(19) United States
(12) Patent Application Publication
(10) Pub. No.: US 2006/0265584 A1
(43) Pub. Date: Nov. 23, 2006

(54) Communication system for traceability monitoring

(75) Inventors: Dominique Bourret, Sonnaz (FR); Denis Genon-Catalot, Chabeuil (FR); Jeremie Nowak, Valence (FR)

Correspondence Address: OLIFF & BERRIDGE, PLC, P.O. BOX 19928, ALEXANDRIA, VA, 22320, US

(73) Assignee: Fidalis, Sonnaz (FR)

(21) Appl. No.: 10/570,515

(22) PCT Filed: Sep. 3, 2004
(86) PCT No.: PCT/FR04/02255

§ 371 Date: Jun. 9, 2006

(30) Foreign Application Priority Data
Sep. 4, 2003 (FR) 03/10476

(51) Int. Cl. H04L 9/00

(52) U.S. Cl. 713/150

(57) ABSTRACT

Communication system for monitoring traceability between at least one upstream operator (2) and at least one downstream operator (3), by way of a controller (4), using a multiplicity (CPUC₁, CPUC₂, CPUCₙ) of identification codes (CPUC), each comprising an identifier (IDU₁, IDU₂, IDUₙ) associated with a multiplicity (14₁, 14₂, 14ₙ) of objects (14) by way of a support (15), the downstream operator (3) having a reader (17, 27) and the controller having under its control a server (9) being devised so as to accomplish the following functions:

declaration of identification of any downstream operator (3),

association (ASSOC1) of this identification code (CPUC) read and of the downstream operator (3) that performed the read, and recording of this association (ASSOC1) in a database (19, 35), accessible to the upstream operator (2).

The present invention relates to a communication system for monitoring traceability.

In the agrofoods field, manufacturers of products undertake traceability of production only up to the point of circulation. They have no direct ties with consumers since the products are marketed by way of a distribution network.

Consequently, manufacturers cannot forewarn consumers, early enough, of any manufacturing defect.

Moreover, consumers seek specific and personalized information about products, in particular about:

their composition, making it possible in particular to advise them about the presence of genetically modified organisms (GMOs), and about nutritional and dietary qualities,

the origin of the products, for ethical reasons of sustainable development, fair trade, the fight to combat child labor, and also to make sure that something originates from a particular locality and that manufacture complies with standards or labels of quality.

It is however difficult to obtain quality of information such as this without a direct relationship with the producer, this relationship making it possible to identify the product in the possession of the consumer, through a record, under the control of the producer, of the profile of the consumer and of the products in his possession.

In the electrodomestic field, manufacturers of products also have no direct ties with the consumer, since the products are marketed by way of a distribution network.

The life cycle of a product may be of the order of several years. The only direct contacts between the consumer and the manufacturer are when something is returned within the context of after-sales service.

On such occasions, it is desirable to be able to establish a history of the product.

Moreover, it is useful for the manufacturer to be able to ascertain the products in the possession of a consumer with a view to plying him with offers corresponding to him and for granting preferential conditions to consumers who make the most purchases of products, based on reliable and accurate data relating to the products purchased by a consumer in particular.

In the same way, it is desirable to be able to identify the parties in the distribution chain who have carried out actions on a given product.

Within the field of distribution, distributors circulate product catalogues in which it is desirable to associate with offers or products present in the catalogue a means of identification allowing the consumer to access offers directly, while allowing the issuer of the offer to recognize the offer to which the consumer is referring and to identify the consumer desiring to benefit therefrom, so as to avoid errors of ordering and to provide a personalized service.

The term traceability signifies in particular here the possibility of associating an object or a unit of a product with a consumer or a downstream operator, distinct from the one who manufactured the object or the product, or an upstream operator.

This traceability must be undertaken at a low associated economic cost, imposing no constraint on the various intermediaries allowing the handling of this product between the upstream operator, for example the manufacturer, and a downstream operator, for example a consumer.

Specifically, the variable nature and the number of intermediaries do not make it possible to set up an operational traceability system.

In numerous fields, it is known to use a marking of the articles or objects produced by a one- or two-dimensional barcode. The aim of this marking is, for example, to identify the type of the article during its sale so as to ensure the upkeep of the inventory, or make it possible to assign a price to the article.

It is also known, in particular through document WO0161624, to use optical readers and barcodes in two dimensions to allow a user to visit a particular Internet page whose address is coded in the pictogram, or to run a computer processing based on the information contained on the pictogram.

It is known moreover, in particular through document FR2813680 to use barcodes to code information making it possible to search for a given URL address in a database.

Such a type of device does not provide any guarantee against the possibilities of hijacking the use of the reader, so as, for example, to create several entries in a base for one and the same product, such a type of action falsifying the traceability data.

A hijacked use may be aimed in particular at obtaining preferential conditions without making the necessary purchases for obtaining these conditions.

Moreover, currently, the marking effected does not uniquely identify each object produced, since two units of one and the same article possess identical marking.

The aim of the present invention is therefore to ensure traceability of the objects produced by allowing an upstream operator to determine for each object produced the downstream operator in possession of this object.

The aim of the invention is also to guarantee the authenticity of the information provided.

For this purpose, the subject of the present invention is a communication system for monitoring traceability between at least one upstream operator and at least one downstream operator, by way of a controller, comprising:

a) under the control of the controller, means of generation of a multiplicity of identification codes, each comprising an identifier; a primary medium or support allowing the storage and/or the transmission of said multiplicity of identification codes to the upstream operator; and a server associated with a means of communication to the downstream operator and a means of communication to the upstream operator,

b) under the control of said upstream operator, means of production of a multiplicity of objects, each object comprising or being associated with a so-called secondary marking support; and means of marking, in a manner readable by means of an appropriate reader, of an identification code on each secondary support of said multiplicity of objects, on the basis of the primary medium or support;

c) under the control of said downstream operator custodian of an object marked according to b), a reader of the identification code of said marked object, the server being devised so as to accomplish the following functions:

declaration of identification of any downstream operator with which the server communicates via the means of communication,

association of this identification code read and of the downstream operator having performed the read,

and recording of this association in a database, accessible to the upstream operator by way of the means of communication, and containing a multiplicity of associations, each association matching an identification code read, with respectively the downstream operator declared as having performed the read.

The system described makes it possible to allocate to each object or unit of a product an identification code subsequently making it possible to associate it with a particular downstream operator, without imposing any constraint on the intermediate steps allowing the object to reach the downstream operator.

Advantageously, the reader comprises an identification part intended for the recording of at least one encrypted unique identification code of the reader.

According to an embodiment, the system furthermore comprises means of configuration of the reader under the control of the controller making it possible to carry out the encryption of the unique identification code of the reader and its recording in the identification part, before the provision of the reader to the downstream operator.

Advantageously, the means of configuration are devised so as to carry out an encryption of the unique identification code of the reader in at least two steps consisting in:

generating a pseudo random sequence on the basis of a series of parameters comprising at least one parameter or combination of parameters guaranteeing a uniqueness, then

carrying out an encryption by a key to obtain the unique identification code of the reader using the parameters of the first step as well as the pseudo random sequence generated during the first step.

According to an embodiment, the identification part of the reader is also intended for the recording of an identification code of the downstream operator under the control of which the reader is situated.

Advantageously, the identification code of the downstream operator is defined during the first read of a product identification code by means of the reader.

According to an embodiment, the parameters used during the encryption of the encrypted unique identification code of the reader comprise:

the date of encryption,

a unique serial number,

a manufacturing code.

Advantageously, an identifier of an intermediate operator carrying out the distribution of the readers to the downstream operators is used as parameter during the encryption of the unique identification code of the reader.

According to an embodiment, the server is devised so as to carry out a recording of an association between a downstream operator and the intermediate operator having distributed the reader in a database.

Advantageously, the recording of the association between a downstream operator and the intermediate operator having distributed the reader is encrypted by means of a key specific to each intermediate operator.

According to an embodiment, the recording of the association between a downstream operator and an upstream operator is encrypted by means of a key specific to each upstream operator.

According to an embodiment, the system is also characterized in that:

each identification code of said multiplicity of identification codes is unique,

each identifier included in an identification code is unique,

the means of marking under the control of the upstream operator, allowing the marking in a manner readable by means of an appropriate reader, on the secondary support of said multiplicity of objects, respectively of said multiplicity of the unique identification codes on the basis of the primary medium or support;

the server is also devised so as to accomplish the function of checking of uniqueness of the unique identification code, read by the downstream operator, by way of the reader, and

the association of the unique identification code read and of the downstream operator having performed the read is one-to-one.

According to this embodiment, the subject of the present invention is therefore a communication system for monitoring traceability between at least one upstream operator and at least one downstream operator, by way of a controller, comprising:

a) under the control of the controller means of generation of a multiplicity of unique identification codes, each comprising an identifier; a primary medium or support allowing the storage and/or the transmission of said multiplicity of unique identification codes to the upstream operator; and a server associated with a means of communication to the downstream operator and a means of communication to the upstream operator,

b) under the control of said upstream operator, means of production of a multiplicity of objects, each object comprising or being associated with a so-called secondary marking support; and means of marking, in a manner readable by means of an appropriate reader, on the secondary support of said multiplicity of objects, respectively of said multiplicity of unique identification codes, on the basis of the primary medium or support;

c) under the control of said downstream operator custodian of an object marked according to b), a reader of the unique identification code of said marked object,

the server being devised so as to accomplish the following functions:

declaration of identification of any downstream operator with which the server communicates via the means of communication,

checking of uniqueness of the unique identification code, read by the downstream operator, by way of the reader,

one-to-one association of this unique identification code read and of the downstream operator having performed the read,

and recording of this association in a database, accessible to the upstream operator by way of the means of communication, and containing a multiplicity of associations, each association matching a unique identification code read, with respectively the downstream operator declared as having performed the read.

According to a possibility, each unique identification code comprises, in addition to the unique identifier at least the identifier of the upstream operator, this identifier allowing matching between a unique identification code and an upstream operator.

Advantageously, each unique identification code additionally comprises the identifier of the type of object marked.

The identifier of the upstream operator included in the unique identification code makes it possible to effect the association between an upstream operator and a unique identification code, without having to store this association in a database. This arrangement is particularly advantageous since it makes it possible to limit the storage space necessary to a database relating to the unique identification codes read by a downstream operator, and not the whole set of unique identification codes generated.

According to another possibility, the server is hooked up with a second database, allowing the storage of the unique identification codes generated and the identifier of the upstream operator to which each unique code is transmitted, allowing matching between a unique identification code and an upstream operator.

This alternative possibility to the unique identification code comprising the identifier of the upstream operator requires a storage space of greater size, but on the other hand makes it possible to simplify the format of the unique identification code, and therefore to use simpler primary and secondary supports, that can contain less data.

Advantageously, the means of generation of the multiplicity of identification codes comprise means of encryption of said codes, and in correspondence the server comprises means of decryption of each identification code read.

The encryption makes it possible to mask the format and the content of the unique identification codes used and to avoid disturbances of the system by third parties.

According to a possibility, each identification code is marked on the secondary support in a format with at least one dimension, in particular a barcode with one dimension.

Advantageously, each identification code is marked on the secondary support in a format with two dimensions or a pictogram.

According to an embodiment, the secondary support is a two-dimensional barcode.

The use of one- or two-dimensional barcodes is a format particularly suited to the system described, in the case or the objects bearing this support are numerous, on account of the simplicity of marking and of the low cost of this support. Moreover, the cost of one- or two-dimensional barcode readers is such as to make it possible to envisage their dissemination to a large number of downstream operators.

According to another possibility, the secondary support is of the type with identification by radio frequency also referred to as RFID.

This arrangement is conceivable in respect of object production runs of smaller batches than barcodes, the marking support, and the associated reader being more expensive, but allowing more convenient reading, the constraints of distance and of relative orientation between the support and the reader being less strict than in the case of an optical barcode reader.

According to yet another possibility, the secondary support is of the digital watermarking, magnetic marking or molecular marking type. According to an embodiment, the server is devised so as, on the one hand, to associate a period of validity with the generated multiplicity of identification codes, and on the other hand to check the validity of each identification code, read by the downstream operator.

The association of a period of validity makes it possible to guarantee the relevance of the associations recorded. Specifically, unique identification codes whose period of validity has expired cannot “pollute” the database.

Advantageously, the upstream operator can, during the marking, append additional traceability information on the secondary support, then access this information during access to the base, this information being recorded by the server.

This information may relate to the circumstances of production, such as the date or the production line.

According to an embodiment, the means of communication between the downstream and upstream operators and the server are of Internet type.

Advantageously, the reader is associated with means making it possible to automatically establish a connection between the downstream operator and the controller.

The invention will be better understood with the aid of the description which follows, with reference to the appended schematic drawing representing two embodiments of this system.

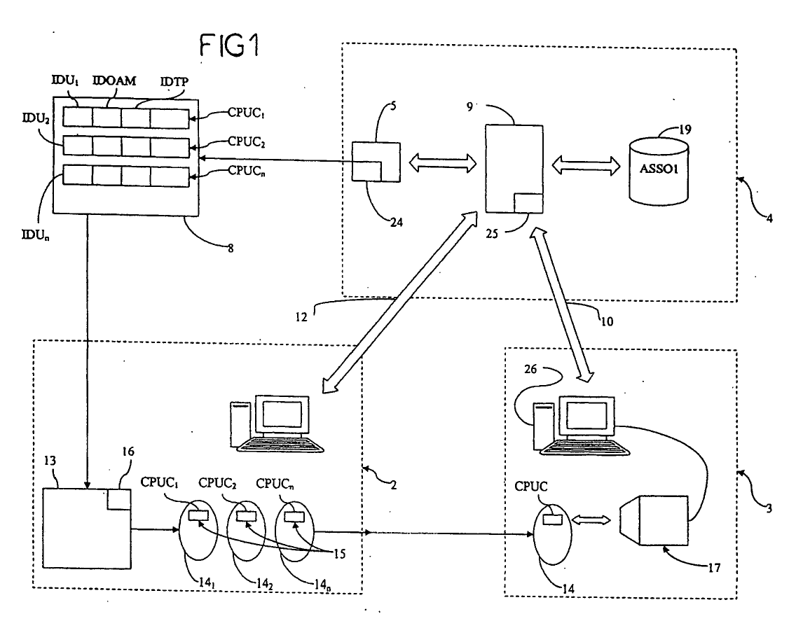

FIG. 1 is an overall schematic view thereof according to a first embodiment.

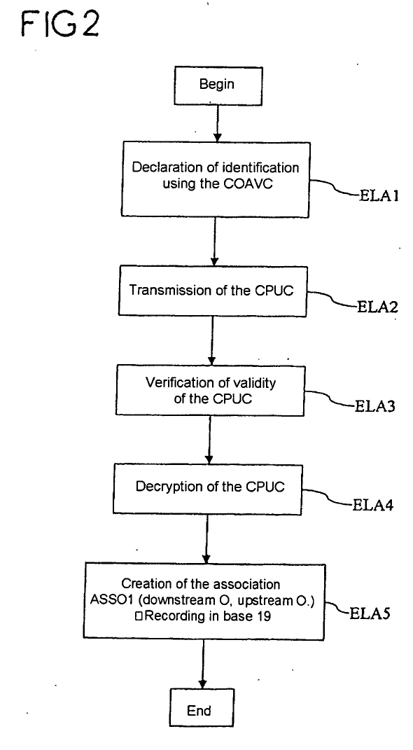

FIG. 2 is a flowchart representing, according to the first embodiment, a reading of a code.

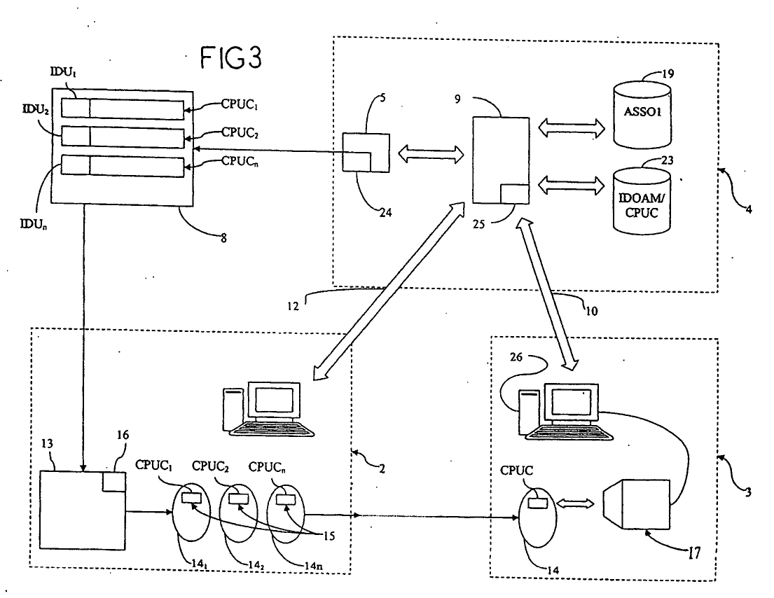

FIG. 3 is an overall schematic view thereof according to a second embodiment.

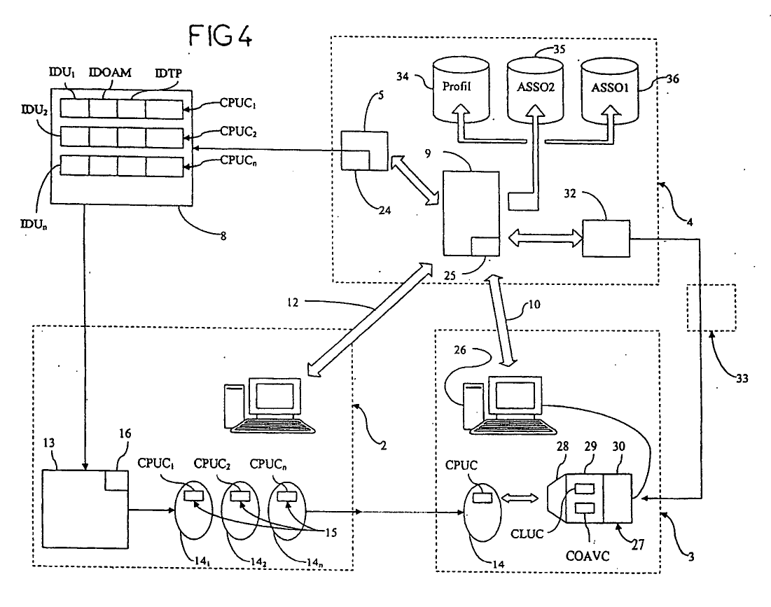

FIG. 4 is an overall schematic view thereof according to a third embodiment.

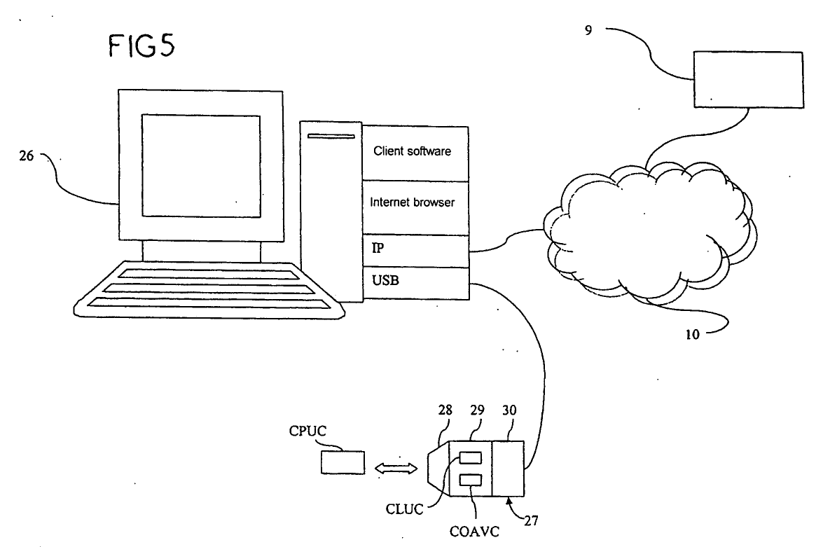

FIG. 5 is a schematic view of a reader and of a computer that are used in the third embodiment.

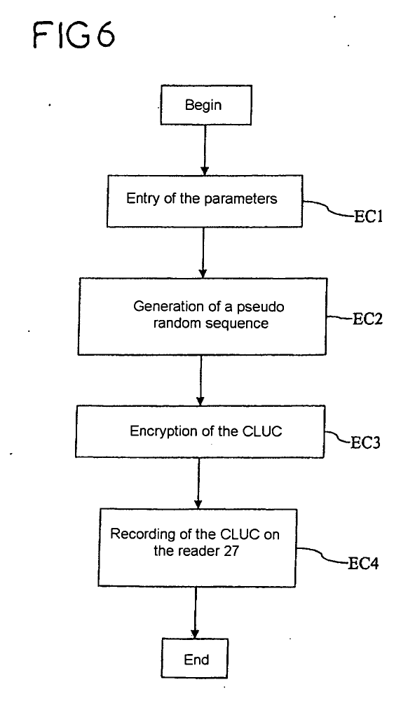

FIG. 6 is a flowchart representing, according to the third embodiment, the initial configuration of the reader.

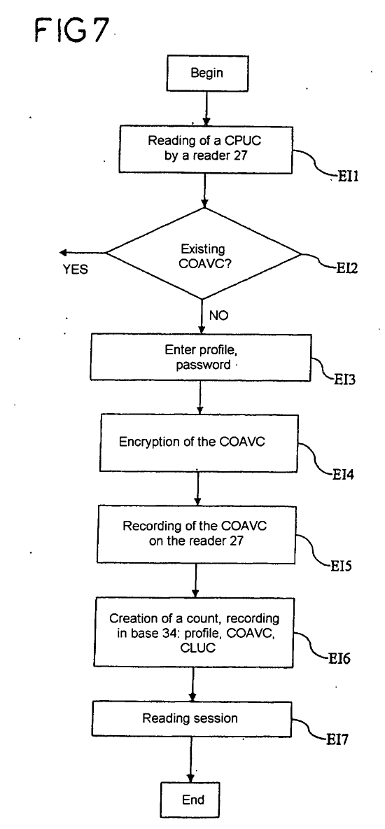

FIG. 7 is a flowchart representing, according to the third embodiment, the initialization of the identifier of the possessor of the reader.

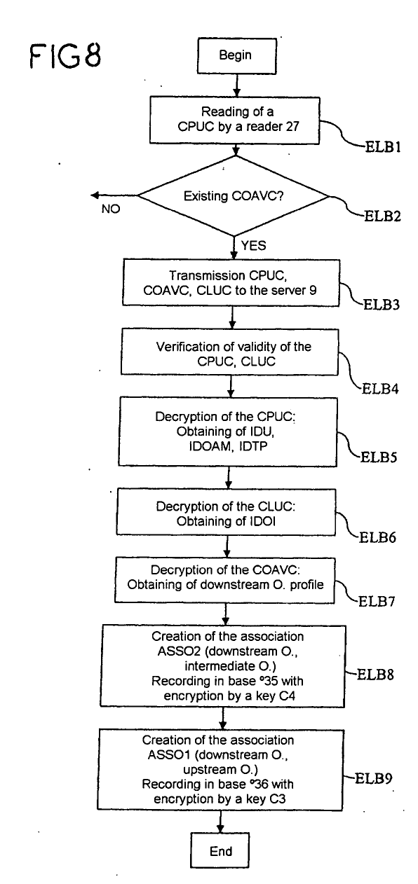

FIG. 8 is a flowchart representing, according to the third embodiment, a reader of a code.

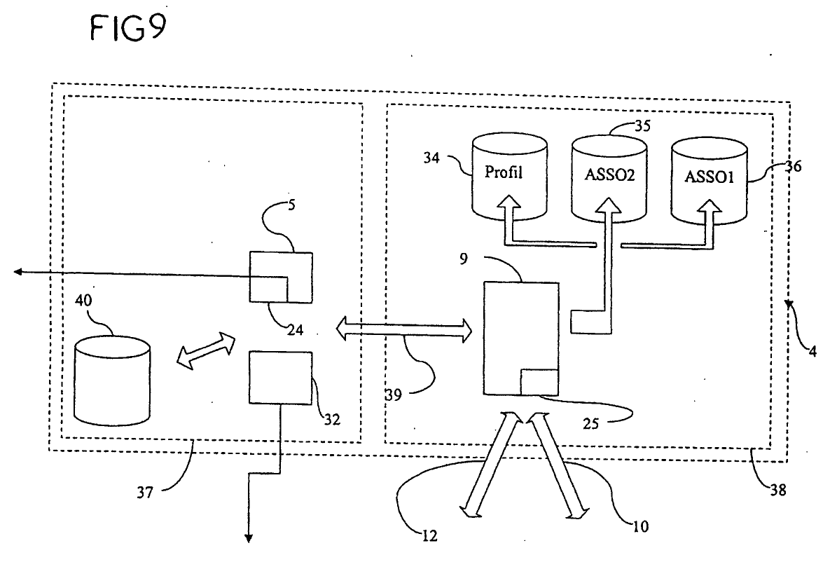

FIG. 9 is a schematic detail view of a variant of the third embodiment.

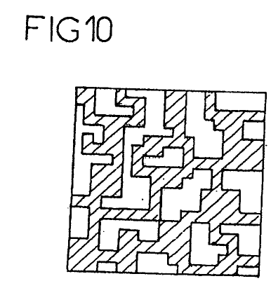

FIG. 10 is a detail view of a two-dimensional barcode.

According to a first embodiment represented in FIG. 1, a system for communication for monitoring traceability according to the invention makes it possible to hook up:

upstream operators, just one of these upstream operators 2 being represented, and being by way of example, a manufacturer 2 of batch products 14,

downstream operators, just one of these downstream operators being represented, and being by way of example, a consumer 3 of batch products 14, and

a controller 4, intermediary between the operators.

The controller 4 is furnished with means of generation 5 of a multiplicity CPU₁, CPU₂, . . . , CPUₙ of unique identification codes or unique product code CPU. Each unique identification code comprises,

a unique identifier IDU, taking a different value IDU₁; IDU₂, . . . , IDUₙ for each element of the multiplicity CPU₁, CPU₂, . . . , CPUₙ of unique identification codes CPU

the identifier IDOAM of the upstream operator 2 to which this code will be transmitted,

the identifier IDTP of the type of product 14 which will be associated with this code,

a period of validity.

The means of generation 5 comprise means in encryption 24 of the unique identification codes CPUC, using encryption algorithms known elsewhere such as public key algorithms, to obtain a unique encrypted identification code of the product CPUC. This encryption uses a first key C1. Moreover, the unique identification codes CPUC may contain supplementary redundancy data intended for verifying the validity of the codes, these redundant data being able to be generated in a manner known elsewhere such as hamming codes.

The multiplicity of codes CPUC₁, CPUC₂, . . . CPUCₙ thus generated by the means of generation 5 are stored, in this embodiment, on a chip card 8. The chip card 8 is transmitted physically to the upstream operator 2.

The products 14 are manufactured by means of production 13 as a multiplicity of units 14₁, 14₂, 14ₙ. To make it possible to identify each of the units 14₁, 14₂, 14ₙ of the product 14, a unique identification code CPUC is applied by way of marking means 16. The marking means 16 make it possible to affix onto the product 14 a two-dimensional barcode 15 of the type represented in FIG. 10, in the form of an adhesive label, in this embodiment. The two-dimensional barcode 15 represents, in encoded form, the unique identification code CPUC.

Each unit 14₁, 14₂, 14ₙ of the product 14 is thus associated respectively with a unique identification code CPUC₁, CPUC₂, . . . CPUCₙ.

During the marking, it is possible for the upstream operator 2 to append information about the barcode 15 in the form of complementary traceability information such as:

the day of production

the year of production

the production line.

Subsequently, a product 14 enters the possession of an intermediary or final consumer 3, or downstream operator, by being transmitted by intermediaries (not represented).

This consumer 3 is furnished with an optical reader 17, making it possible to read the barcodes 15, linked to a computer 26 possessing an Internet connection 10 and a suitable software (not represented) allowing the transmission of the unique identification code CPUC to the controller 4.

The controller 4 is furnished with a computer server 9 accessible from the Internet 10, 12 directly or through diverse means of computer protection such as a firewall, thus being furnished with a means of communication to the manufacturers 2 (upstream operators) and to the consumers 3 (downstream operators).

The server 9 is devised so as to accomplish the following functions.

During the first read, for example, the server makes it possible to carry out the registration of a consumer, who fills in a form in which he indicates personal information such as his name Q1 and his address Q2 and the date of registration Q3. A password is assigned or chosen by the consumer. An identification code of the consumer or downstream operator code COAVC is assigned to the consumer and stored both on the server 9 and on the computer 26 or on the reader.

The server is also devised so as to carry out the following functions, during the reading of a unique code CPUC, as represented in FIG. 2. In a first step ELA1, the server 9 allows the declaration of identification of any consumer 3 whose registration has been carried out, while the consumer was connected. This identification of the consumer may be carried out without action by a human operator, using certificates on the computer 26, or using an identification by password and identifier of the consumer. In both cases, the aim is to obtain the identification code of the consumer COAVC and to carry out a verification.

In a second step ELA2, the unique identification code CPUC of a product read by the reader 17 is transmitted to the server 9 by the means of communication 10.

In a third step ELA3, the server. 9 allows, once the consumer is identified, the checking of the validity of the unique identification code CPUC, read by the consumer 3 by virtue of the reader 17 and transmitted to the server.

The checking of validity comprises steps of verification of the syntax and of the consistency of the data by the use of an algorithm known elsewhere as hamming codes.

Moreover, the unique identification code CPUC comprises an item of information regarding period of validity making it possible to refuse the transmission of the code if this period is over.

In a fourth step ELA4, the server 9 comprises means of decryption 25 making it possible to obtain the unique identification code CPUC in interpretable form making it possible to read the information contained in this code.

In a fifth step ELA5, the server 9 then creates a one-to-one association ASSOC1 of this unique identification code CPUC read and of the consumer 3 that performed the read, represented by the COAV code thereof, then records this association ASSOC1 in a database 19 if this association ASSOC1 is not already existing in the database 19. This makes it possible to avoid double recording of an association.

The server additionally records in the base 19 the complementary traceability information transmitted likewise by the reader.

The information of the database 19 is accessible to the manufacturers 2 by means of the Internet access 12. Each unique identification code CPUC contains the identifier of the manufacturer IDOAM. A query pertaining to this identifier therefore allows the server 9 to select and to present to the manufacturer 2 a multiplicity ASSOC1₁, ASSOC1₂, ASSOC1ₙ of associations ASSOC1, each association ASSOC1 matching a unique identification code CPUC read corresponding to a unit of product 14 originating from the manufacturer 2, with respectively the consumer 3 who performed the read.

The manufacturer 2 is thus furnished with traceability of each unit of the product 14, which allows him also to append complementary traceability information.

The period of validity associated with the unique identification code also allows the server 9 to periodically carry out on the base 19 a deletion or an archiving onto another support of tape type, of the associations ASSOC1 relating to codes CPUC that have exceeded their period of validity, and thus to limit the storage space required.

The embodiment represented hereinabove uses a format of unique identification code CPUC comprising information about the manufacturer 2, as well as about the product 14. This embodiment makes it possible to limit the storage space required for the server 9 to the database 19, storing only information about the unique identification codes CPUC read, and not about the whole set of unique identification codes CPUC generated.

A second embodiment, represented in FIG. 3, uses an identification code CPUC containing chiefly a unique identifier IDU, thus simplifying the format of the unique identification code CPUC, but using a second database 23.

In this system, the means of generation 5 of unique identification code CPUC generate a code CPUC of simplified format comprising chiefly a unique identifier IDU, and possibly additional data. The means of generation 5 then forward to the server 9, for each unique identification code CPUC, the association between the unique identification code CPUC and the identifier IDOAM of the manufacturer 2 for which this unique identification code CPUC is intended.

The server 9 records in the second database 23 this association.

Thus, during the transmission of a unique identification code CPUC by a consumer 3, the server records in an identical fashion the one-to-one association ASSOC1 of this unique identification codes CPUC read and of the identifier of the consumer 3 who performed the read in the database 19. However, during access by a manufacturer 2, each unique identification code CPUC not containing the identifier IDOAM of the manufacturer 2, a query pertaining to this identifier does not allow the server 9 to select and to present to the manufacturer 2 the associations ASSOC1 relating to it as in the first embodiment. In this case the server must firstly perform a first query on the database 23 to identify the unique identification codes CPUC relating to the manufacturer 2, then subsequently perform a second query on the base 19 so as to determine the associations ASSOC1 relating to the unique identification codes CPUC identified during the first query and to provide the corresponding associations ASSOC1 to the manufacturer 2.

According to a variant, during the transmission of a unique identification code CPUC by a consumer 3, the server 9 searches through the database 23 for the identifier IDOAM of the manufacturer 2 corresponding to the unique identification code CPUC read and records in an identical fashion the one-to-one association ASSOC1 matching this unique identification code CPUC read corresponding to a unit of product 14 originating from the manufacturer 2 with respectively the consumer 3 who performed the read, while appending the identifier IDOAM to this association ASSOC1, in such a way as to allow a search in a single step during an interrogation by a manufacturer 2.

The embodiments presented hereinabove allow the use of readers of simple and standard type, which are not identified, any identification of the consumer being based on a first phase of registration, in particular of on-line registration.

According to a third embodiment, represented in FIGS. 4 to 8, the reader is of a different type, so as to be able to be identified in a unique and secure fashion, so as to guarantee the authenticity of the data input into the base.

This embodiment reuses elements of the first embodiment, the identical elements bearing the same references. Only the differences with respect to this first embodiment will be explained explicitly hereinbelow.

In this embodiment, the consumer 3 is furnished, as represented in FIG. 5, with an optical reader 27, making it possible as previously to read the barcodes 15, linked to a computer 26 comprising,

a component for communication with the reader, for example using the USB protocol,

client software allowing communication with the reader, with a view to transmission of information, such as the unique identification code CPUC to the controller 4.

a network card allowing it to be linked by a means of communication of Internet connection type 10 to the server 9.

an Internet browser.

It is obvious that numerous alternatives of its various components may be used. Thus the connection to the Internet and to the reader may be performed by wired or wireless means. It is also possible to use instead of a personal computer some other type of device, such as a portable telephone, which can also comprise components fulfilling the same functions.

The reader 27 comprises, as represented in FIG. 4:

a sensor part 28 allowing the reading of an identification code CPUC and consisting for example of an optical sensor,

a unique identification part 29 of the reader making it possible to record identification codes,

a communication part 30 making it possible to transfer the data to a computer 26, as illustrated in FIG. 3, or to a portable telephone or else directly by a means of network communication to the server 9. The sensor part 28 and communication part 30 are common to the other embodiments.

The unique identification part 29 makes it possible to store, for example on a component of SIM card type:

a unique encrypted identification code of the reader or unique encrypted reader code CLUC and

a unique identification code of the consumer who is the possessor of the reader, that is to say the upstream operator code COAV in its encrypted form called COAVC.

In this embodiment, the reader is provided by the controller, the latter effecting the determination and the recording of the unique identification code of the reader CLUC by means of configuration 32, during a configuration phase the flowchart of which is represented in FIG. 6.

In a first step EC1, the following parameters are provided to the configuration means 32 by the. controller:

the date of initialization P1

a unique serial number P2

a manufacturing code P3

a parameter P4 corresponding to an identifier IDOI of an intermediate operator 33 distributing the readers to the downstream operators 3, this operator possibly being different from the manufacturer 2 and from the controller 4.

It is obvious that other types of parameters could be used, as well as a different number of parameters. It is necessary however that the combination of these parameters exhibits a character of uniqueness.

In a second step EC2, an algorithm A0 is used, to generate a pseudo random sequence S on the basis of the parameters P1 to P4, this being symbolized by the formula below:
A0(P1, P2, P3, P4)=S

The term pseudo random signifies here that two identical sequences S can be obtained only by applying this algorithm to two identical quadruples (P1, P2, P3, P4), the algorithm therefore being injective.

In a third step EC3, an encryption algorithm A1 is used to generate the identifier CLUC with the encryption key C1, on the basis of the parameters P1 to P4 and of the sequence S, this being symbolized by the formula below:
A1_{C1}(P1, P2, P3, P4, S)=CLUC

In a fourth step EC4, the identification code CLUC is recorded in the unique identification part 29 of the reader 27.

The configuration is then completed as regards the determination and the recording of the unique identification code of the reader CLUC.

It is particularly advantageous to use two generating steps since this method makes it extremely difficult to decrypt the code CLUC so as to retrieve the initial parameters P1, P2, P3, P4.

The parameters P1 to P4 are known only to the controller and are not communicated over a network, thereby also contributing to the security of the data.

The unique identification code of the consumer COAV in its encrypted form called COAVC is itself determined and recorded on the reader 27, in the unique identification part 29 during the first read performed using the reader as represented in FIG. 7.

In a first step EI1, the reading of a unique identification code CPUC of an object is performed, by means of the reader 27 by the possessor of the reader.

In a second step EI2, means of processing on the computer 26 or directly on the reader 27 make it possible to determine whether the identification code of the consumer COAVC has been or has not been recorded in the unique identification part 29 of the reader 27.

If the response is negative, this is a first read, and in a third step EI3, the browser of the consumer associated with the reader 27, for example on the computer 26, is directed to a web page, preferably with a secure mode of transaction of HTTPS type.

The consumer is then invited to fill in a registration form in which his profile is recorded in the form of a set of parameters comprising for example his name Q1 and his address Q2 and the date of registration Q3. A password is assigned or chosen by the possessor.

In a fourth step EI4, an encryption algorithm A2 is thereafter used to generate the identification code COAVC, on the basis of the parameters Q1, Q2 and Q3, this being symbolized by the formula below:
A2(Q1, Q2, Q3)=COAVC

The generation of the code COAVC is here simpler than for the identification code CLUC.

It should be noted that the set of parameters making it possible to generate the identification code COAVC is exchanged over a network, in contradistinction to the identification code CLUC.

It is not therefore useful to establish a level of encryption higher than that of the communication of these data.

In a fifth step EI5, the identification code COAVC is recorded in the unique identification part 29 of the reader 27.

In a sixth step EI6, a consumer count 3 is created by the server 9, and the data provided, comprising:

the profile of the consumer consisting of the parameters Q1 to Q3, the password, as well as other additional information requested of the consumer during step EI3,

the identification code of the consumer COAVC,

the unique identification code of the reader CLUC under the control of the consumer are recorded in a database 34, these data being encrypted with a key C2, specific to each consumer 3.

The operations of initializing the consumer count are then completed.

In a seventh step EI7, the operations of reading a unique code CPUC may be carried out, which will be described hereinbelow.

The operations corresponding to the reading of a unique identification code of a product CPUC by the reader 27 are represented in FIG. 8.

In a first step ELB1, the reading of a unique identification code CPUC of an object is performed, by means of the reader 27 by the possessor of the reader.

In a second step ELB2, means of processing on the computer 26 or directly on the reader make it possible to determine whether the identification code of the consumer COAVC has been or has not been recorded in the unique identification part 29 of the reader 27.

If the response is negative, this is a first read, and the steps described hereinabove relating to the determination and the recording of the identification code COAVC are performed, as illustrated in FIG. 7.

If the response is positive, in a step ELB3, the following information,

the unique identification code CPUC of a product read by the reader 27,

the unique identification code CLUC of the reader 27,

the identification code COAVC of the consumer, are transmitted to the server 9 by the means of communication 10.

In the step ELB4, the server 9 effects a verification of the validity of the unique identification codes of the reader CLUC and of the product CPUC.

Moreover, the unique identification code CPUC comprises an item of information regarding the period of validity making it possible to refuse the transmission of the code if this period is over.

Thus, it is in particular verified whether the unique identifier of the product has not already been used during a previous read, in a database 35. This makes it possible to avoid the double recording of an association.

The verification of the validity of the identification code CLUC, and of the correspondence of this code with the identification code of the consumer COAVC makes it possible to make the declaration of identification of the consumer 3.

In a step ELB5, a decryption of the unique identification code of the product CPUC makes it possible to obtain the following information,

the unique identifier IDU, of the product, that may for example be a serial number,

the identifier IDOAM of the upstream operator 2 to which this code will be transmitted,

the identifier IDTP of the type of product 14.

In a step ELB6, a decryption of the identifier CLUC makes it possible to obtain, the identifier IDOI of an intermediate operator 33 that distributed the reader 27 to the consumer 3.

In a step ELB7, a decryption of the identification code COAVC makes it possible to identify the consumer 3, whose profile is recorded in the database 34.

In a step ELB8, a recording of an association ASSO2 between a consumer 3 and the intermediate operator who distributed the reader is performed in a database 35, with information about the profile of the consumer, this association being encrypted with an encryption key C4 specific to the intermediate operator.

In a step ELB9, the server 9 creates a one-to-one association ASSOC1 of the unique identification code CPUC read and of the consumer 3 who performed the read, represented by the COAV code thereof, then records this association ASSOC1 in a database 36, if this association ASSOC1 does not already exist in the database 36, this association being encrypted with an encryption key C3 specific to the manufacturer 2 or upstream operator.

The read is then completed. It is possible to append steps making it possible to bring up on an Internet browser of the consumer an HTML page whose information is personalized, by virtue of the data of the profile of the consumer and of the data about the product which he has in his possession.

The server additionally records in the base 36 the complementary traceability information transmitted likewise by the reader.

As previously, the information of the database 36 is accessible to the manufacturers 2 by means of the Internet access 12.

The data are made secure by encryption by a key C3 specific to each manufacturer.

Moreover, in this embodiment, the information for the database 35 is accessible to the intermediate operators who distributed the readers to the consumers by means of the Internet access 12.

The data are made secure by encryption by a key C2 specific to each of these intermediate operators.

It should be noted that in this embodiment, the product unique identification codes CPUC and the reader unique identification codes CLUC are encrypted with the same key C1 which remains under the control of the controller. The encryption and decryption of these codes are carried out under the control of the controller, thus guaranteeing enhanced security of the data.

The other data, which are called on to be encrypted and decrypted by different operators are encrypted with different keys, thus making it possible to safely segregate the data which each operator of the system can access.

According to a variant, for which only the elements under the control of the controller are represented in FIG. 9, the means of generation 5 of a multiplicity CPU₁, CPU₂, . . . , CPUₙ of unique identification codes as well as the means of configuration 32 are situated on a first site 37, distinct from a second site 38 on which is situated the server 9 and the databases 34 to 36, these two sites being linked by a means of communication 39. According to this variant, only public keys are communicated from the first site 37 to the second site 38 to allow the decryption of the product unique codes encrypted CPUC by the server. The private key remains at the level of the first site, and can be stored for example in a base 40. The private key C1 is not therefore communicated by the network.

A further application of the first to third embodiments of the invention using a unique identification code for the products, consists of a means of combating piracy of CD-ROMS or similar supports for video games intended for network game playing. Specifically, the association of a unique printed code with the CD-ROM and the code of the reader which performed the read makes it possible to authenticate the consumer and authorize the latter to use the game with other players connected to a network game playing site.

According to a fourth embodiment, the identification codes are not unique. In particular, the identification codes are associated with the articles in a publication, for example a catalogue. In this case, each copy of the catalogue comprises like articles.

The manner of operation is identical to that set forth in the third embodiment, except that a product identification code may appear several times.

However, it is possible to retain the uniqueness of the associations between the consumer and the article identification code, and to register this information once only.

These arrangements are advantageous for example within the framework of promotions identified by a number, from which several consumers can benefit and from which the consumer can benefit just once.

Moreover, nowadays it is known to make payments with a simple credit card number, with no verification of secret code, this constituting a low level of security. The system described makes it possible to achieve, by reading a product code, not necessarily unique, reliable recognition of the reader and hence of the consumer, and an association between the product and the consumer, making it possible to validate the transaction.

According to other embodiments (not represented), the communication system can use, as replacement for the chip cards 8, other primary supports such as a flexible diskette. It is also possible to use direct transmission of the unique identification codes between the controller and the upstream operator via a secure link, via an Internet network or a point-to-point link.

Moreover, the secondary support may, as replacement for the barcodes, consist of a physical support using an identification by radio frequency, and also called RFID. The readers provided to the consumers then being readers of this type of support.

According to other variant, the secondary support may be constituted by a digital watermarking of an image, also called tattooing. In this case, the reader may be an optical reader fitted with hardware or software image processing means.

It is also possible to transfer the images directly by the means of communication to the server, the latter being devised so as to carry out the processing, this arrangement necessitating, however, a server exhibiting more calculational power.

According to yet another variant, the support may be constituted by a magnetic support. In this case, the reader used is a magnetic reader.

According to yet another variant, the secondary support may be constituted by a molecular marking. The sensor part of the reader having also to be suitably adapted to such a type of marking.

The invention is not limited to the forms of execution described, on the contrary it encompasses all variants thereof.

Thus, in particular, the means of communication used may be different from an Internet link.

The means of communication and of exchange may be diverse, both in respect of the exchange format used for which numerous standards exist or are forthcoming, among which may be cited in a nonlimiting manner the IP or MPLS standards, and for the physical support used for which numerous standards exist or are forthcoming, among which may be cited in a nonlimiting manner the standards 802.3, 802.5, 802.11, 802.16, GSM, GPRS, UMTS.

The secondary support used may also exhibit different forms, so as to use for example instead of an adhesive label, direct printing on the product.

Other types of marking and of readers may also be used.

Moreover, the computer present at the upstream operator level may be replaced with a telephone or portable telephone or other telematic device to which a reader may be linked or with which the latter may be integrated.

The concept of server should moreover be interpreted as a logical entity. Specifically, it is known to use several physical servers to fulfill one and the same function in order to obtain better security or higher performance.

1-22. (canceled)

23. Communication system for monitoring traceability, intended for communicating between at least one upstream operator and at least one downstream operator, by way of a controller, comprising:
a) a first subsystem, intended to be placed under the control of the controller, comprising:
means of generation of a multiplicity of identification codes, each comprising an identifier
a primary medium or support allowing the storage and/or the transmission of said multiplicity of identification codes to the upstream operator; and
a server associated with a means of communication,
b) at least one second subsystem, intended to be placed under the control of an upstream operator, and comprising:
means of production of a multiplicity of objects, each object comprising or being associated with a so-called secondary marking support; and
means of marking, in a manner readable by means of an appropriate reader, of an identification code on each secondary support of said multiplicity of objects, on the basis of the primary medium or support;
c) at least one third subsystem, intended to be made available to a downstream operator identified by a downstream operator identification code comprising:
a reader of the identification code of the said marked object,
the server comprising:
means of declaration of identification of any downstream operator with which the server communicates via the means of communication,
means of association of this identification code read and of the downstream operator having performed the read,
and a database for recording this association, accessible to the upstream operator by way of the means of communication, and containing a multiplicity of associations, each association matching an identification code read, with respectively the downstream operator declared as having performed the read,
characterized in that
the means of declaration of identification of the server comprise means of verification of the validity of the identification code, and of the correspondence of this code with the identification code of the downstream operator,
and in that
the first subsystem furthermore comprises means of configuration of the reader devised so as to carry out an encryption of the encrypted unique identification code of the reader and its recording in the identification part, comprising:
means of generating a pseudo random sequence on the basis of a series of parameters comprising at least one parameter or combination of parameters guaranteeing a uniqueness, and
means of encryption by a key to obtain the unique identification code of the reader using said series of parameters as well as the pseudo random sequence.

24. System according to claim 23, characterized in that the identification part of the reader is also intended for the recording of an identification code of the downstream operator under the control of which the reader is situated.

25. System according to claim 24, characterized in that the system comprises means suitable for the definition of the identification code of the downstream operator during the first read of a product identification code by means of the reader.

26. System according to claim 24, characterized in that the parameters used during the encryption of the encrypted unique identification code of the reader comprise:
the date of encryption,
a unique serial number,
a manufacturing code.

27. System according to claim 24, characterized in that an identifier of an intermediate operator carrying out the distribution of the readers to the downstream operators is used as parameter by the means of configuration of the reader that are intended to carry out the encryption of the unique identification code of the reader.

28. System according to claim 27, characterized in that the server is devised so as to carry out a recording of an association between a downstream operator and the intermediate operator having distributed the reader in a database.

29. System according to claim 28, characterized in that the recording of the association between a downstream operator and the intermediate operator having distributed the reader are encrypted by means of a key specific to each intermediate operator.

30. System according to claim 28, characterized in that the recording of the associations between a downstream operator and an upstream operator are encrypted by means of a key specific to each upstream operator.

31. System according to claim 23, characterized in that:
each identification code of said multiplicity of identification codes is unique,
each identifier included in an identification code is unique,
the means of marking under the control of the upstream operator, allowing the marking in a manner readable by means of an appropriate reader, on the secondary support of said multiplicity of objects, respectively of said multiplicity of the unique identification codes on the basis of the primary medium or support;
the server is also devised so as to accomplish the function of checking of uniqueness of the unique identification code, read by the downstream operator, by way of the reader, and
the association of the unique identification code read and of the downstream operator having performed the read is one-to-one.

32. System according to claim 31, characterized in that each unique identification code comprises, in addition to the unique identifier at least the identifier of the upstream operator, this identifier allowing matching between a unique identification code and an upstream operator.

33. System according to claim 32, characterized in that each unique identification code additionally comprises the identifier of the type of object marked.

34. System according to claim 31, characterized in that the server is hooked up with a second database, allowing the storage of the unique identification codes generated and the identifier of the upstream operator to which each unique code is transmitted, allowing matching between a unique identification code and an upstream operator.

35. System according to claim 23, characterized in that the means of generation of the multiplicity of identification codes comprise means in encryption of said codes, and in correspondence the server comprises means of decryption of each identification code read.

36. System according to claim 23, characterized in that each identification code is marked on the secondary support in a format with at least one dimension, in particular a barcode with one dimension.

37. System according to claim 23, characterized in that each identification code is marked on the secondary support in a format with two dimensions.

38. System according to claim 37, characterized in that the secondary support is a two-dimensional barcode or a pictogram.

39. System according claim 23, characterized in that the secondary support is of the type with identification by radio frequency also referred to as RFID.

40. System according to claim 23, characterized in that the secondary support is of the digital watermarking, magnetic marking or molecular marking type.

41. System according to claim 23, characterized in that the server is devised so as, on the one hand, to associate a period of validity with the generated multiplicity of identification codes, and on the other hand to check the validity of each identification code, read by the downstream operator.

42. System according to claim 23, characterized in that the upstream operator can, during the marking, append additional traceability information on the secondary support, then access this information during access to the base, this information being recorded by the server.

43. System according to claim 23, characterized in that the means of communication between the downstream and upstream operators and the server are of Internet type.

44. System according to claim 23, characterized in that the reader is associated with means making it possible to automatically establish a connection between the downstream operator and the controller.
